(19) United States
(12) Patent Application Publication
(10) Pub. No.: US 2026/0152164 A1
(43) Pub. Date: Jun. 4, 2026

(54) ELECTROMECHANICAL BRAKE COMPRISING A MOTOR HOUSING MANUFACTURED BY WAY OF A CUP EXTRUSION STEP

(71) Applicant: Robert Bosch GmbH, Stuttgart (DE)

(72) Inventor: Dietmar Kratzer, Hersbruck (DE)

(21) Appl. No.: 19/398,290

(22) Filed: Nov. 24, 2025

(30) Foreign Application Priority Data
Nov. 29, 2024 (DE) 10 2024 211 446.4

(51) Int. Cl. B60T 13/74; F16D 55/226; F16D 65/18; F16D 121/24; F16D 125/40; H02K 5/10

(52) U.S. Cl. CPC B60T 13/746; F16D 55/226; F16D 65/18; F16D 2121/24; F16D 2125/40; F16D 2200/003; F16D 2250/0023; H02K 5/10

(57) ABSTRACT

An electromechanical brake for a motor vehicle. The electromechanical brake includes an electric motor which rotationally drives a spindle drive unit arranged in a brake caliper housing, such that a brake actuator for applying a braking force is displaceable in an axial direction of the brake caliper housing. A motor housing arranged on the brake caliper housing accommodates the electric motor, and a control unit housing of a control unit that controls the electric motor is arranged on the motor housing. The motor housing is made of a metal material and forms a cup-shaped accommodating space in which the electric motor is accommodated. The motor housing is closed by the control unit housing, and the motor housing is formed by way of a cup extrusion step.

### FIELD

The present invention relates to an electromechanical brake for a motor vehicle and to a motor vehicle having such an electromechanical brake.

### BACKGROUND INFORMATION

The service brake is usually a brake that uses brake fluid to press a brake piston, together with a brake pad, onto a brake disk in order to brake the vehicle. As more and more constituent units in the motor vehicle are becoming electric, the service brake is also to be designed as an electromechanical brake, such that brake fluid and the associated complex valve and line structure can be dispensed with. Such an electromechanical brake could also significantly reduce maintenance requirements.

PCT Patent Application No. WO 2023/166434 A1 describes a brake caliper for a disk brake. The brake caliper comprises a brake caliper housing on which a transmission housing is arranged. A control housing, which houses an electric motor and a brake control unit that controls the electric motor, is attached to a rear side of the transmission housing.

Germany Patent No. DE 10 2009 046 044 B4 describes an electromechanically actuatable disk brake for a motor vehicle.

The electromechanically actuatable disk brake comprises a caliper housing which surrounds a brake disk. The caliper housing has a housing-like recess, in which an electric motor of the brake is arranged. Arranged above the electric motor and the caliper housing is a gear transmission, via which a spindle drive unit arranged in the caliper housing is driven. A circuit carrier of a control unit is provided above the gear transmission, via which control unit the electric motor can be controlled. The circuit carrier and the gear transmission are closed off from the outside by a cover.

### SUMMARY

An object of the present invention includes providing a motor vehicle electromechanical brake which is simpler and more economical to manufacture and better protected against environmental conditions such as dirt and moisture.

The object may be achieved by an electromechanical brake having certain features of the present invention. Preferred example embodiments of the present invention are disclosed herein.

The present invention provides an electromechanical brake for a motor vehicle. According to an example embodiment of the present invention, the electromechanical brake comprises an electric motor which rotationally drives a spindle drive unit arranged in a brake caliper housing, such that a brake actuator for applying a braking force is displaceable in an axial direction of the brake caliper housing. A motor housing arranged on the brake caliper housing accommodates the electric motor, and there is arranged on the motor housing a control unit housing of a control unit that controls the electric motor. The motor housing is made of a metal material and forms a cup-shaped accommodating space in which the electric motor is accommodated. The motor housing is closed by the control unit housing, and the motor housing is formed by way of a cup extrusion step.

A cup-shaped accommodating space is understood to be a space which is open only at one axial end. According to the present invention, the motor housing needs to be protected only at its axial end from the ingress of dirt and moisture. This means that fewer sealing points are needed. At this axial end, the motor housing is closed by the control unit housing. Therefore, no separate cover is needed to close the motor housing. This allows the number of parts and the weight of the electromechanical brake to be reduced. To further reduce weight, the motor housing is preferably made of an aluminum material.

According to an example embodiment of the present invention, in a cup extrusion step, a workpiece blank is made into the desired shape between a die and a punch by means of cold forming. Therefore, no waste material in the form of chips is produced during the manufacture of the motor housing. This allows the motor housing to be manufactured more economically. Furthermore, such a cup extrusion step achieves high dimensional and shape accuracy, such that post-processing can generally be dispensed with. By using such a step to manufacture the motor housing, a higher production rate can be achieved in the same amount of time than by machining. This also makes it possible to manufacture such a motor housing more economically.

In a preferred embodiment of the present invention, the motor housing is formed by way of a forward cup extrusion step. In a forward cup extrusion step, the material flows in the same direction as the movement of the punch. The advantage of a forward cup extrusion step over a sideways cup extrusion step is that the motor housing has an advantageous structure orientation.

In an alternative embodiment of the present invention, the motor housing is formed by way of a backward cup extrusion step. In a backward cup extrusion step, the material flows in the opposite direction to the movement of the punch. The advantage of a backward cup extrusion step over a sideways cup extrusion step is that the motor housing has an advantageous structure orientation.

In a further alternative embodiment of the present invention, the motor housing is formed by way of a sideways cup extrusion step. In a sideways cup extrusion step, the material flow is oriented perpendicular to a movement of the punch. Such an extrusion step can achieve an advantageous structure orientation for certain applications.

In an advantageous development of the present invention, a seal is arranged between an edge of the accommodating space and the control unit housing. A seal between the control unit housing and the edge of the accommodating space can provide said accommodating space even better protection against dirt and moisture.

Advantageously, the seal is a wet seal. A wet seal has the advantage that liquid cannot collect in the sealing region in front of the seal, making said seal more robust against seal infiltration than solid seals.

In a further advantageous embodiment of the present invention, the seal is an elastic solid seal. Solid seals have the advantage of requiring no surface pretreatment, such as laser cleaning or plasma cleaning, before silicone is applied.

According to an expedient embodiment of the present invention, one edge of the accommodating space is machined. Such machining can, for example, create a recess for a seal. Furthermore, machining allows a height of the edge to be adjusted on the basis of the size of the electric motor used. Therefore, only one type of motor housing is needed, which can be used for different sizes of electric motors. This means that only one die and one punch are needed to be able to form different motor housings. Since such dies and punches are expensive to manufacture, different sizes of motor housings can also be produced economically.

According to a further expedient embodiment of the present invention, the accommodating space accommodates a parking brake device in addition to the electric motor. The electromechanical brake can be fastened in a braked position via a parking brake device. This allows the motor vehicle to be stopped without power even when the motor is switched off. By arranging the parking brake device in the accommodating space, a separate housing for the parking brake device can be dispensed with. This allows the number of parts for the mechanical brake to be reduced.

The present invention also provides a motor vehicle having such an electromechanical brake. With such a motor vehicle, the advantages and properties described above are achieved.

Exemplary embodiments of the present invention are explained in more detail in the following description and are illustrated in the figures.

### BRIEF DESCRIPTION OF THE DRAWINGS

FIG. 1 is a sectional view of an electromechanical brake according to an exemplary embodiment of the present invention.

FIG. 2 is a sectional view of the motor housing according to an example embodiment of the present invention.

### DETAILED DESCRIPTION OF EXAMPLE EMBODIMENTS

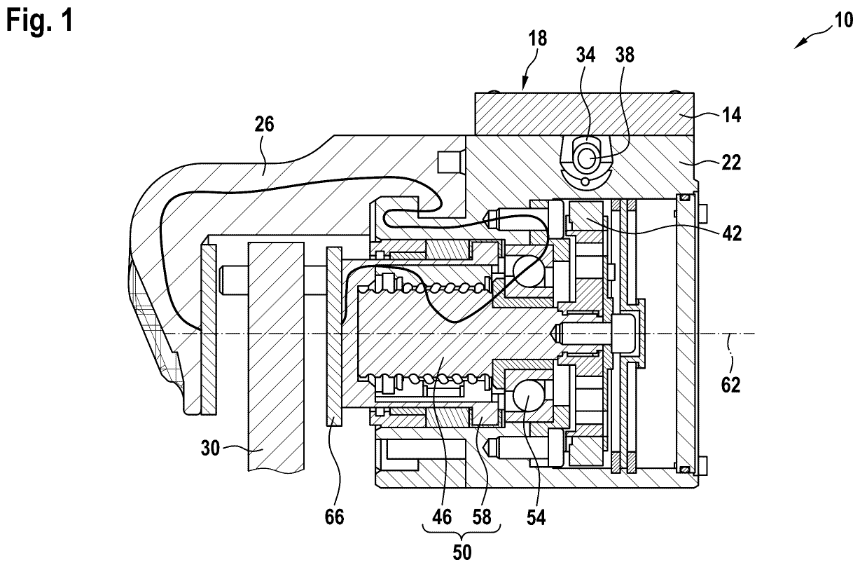

FIG. 1 is a sectional view of an electromechanical brake 10 according to an exemplary embodiment of the present invention. The electromechanical brake 10 comprises an electric motor 18 arranged in a motor housing 14. The motor housing 14 is arranged on a brake caliper housing 22 of the electromechanical brake 10. Additionally, the electromechanical brake 10 comprises a brake caliper 26 which covers a brake disk 30 and is connected to the brake caliper housing 22. The electric motor 18 comprises a worm 38 arranged on a motor shaft 34, which worm extends into the brake caliper housing 22 and drives a worm wheel 42. The worm wheel 42 is attached to a spindle 46 of a spindle drive unit 50 arranged in the brake caliper housing 22. As a result, the spindle 46 is driven rotationally. The spindle 46 is rotatably mounted in the brake caliper housing 22 via a bearing 54. By rotating the spindle 46, a spindle nut 58 of the spindle drive unit 50 can be displaced in an axial direction 62.

In the exemplary embodiment shown, the spindle drive unit 50 is designed as a ball screw drive. A brake actuator 66 is arranged on the spindle nut 58, which brake actuator in this exemplary embodiment is designed as a brake pad. By displacing the spindle nut 58 with the brake pad 66, said brake pad can be applied to the brake disk 30 in order to brake.

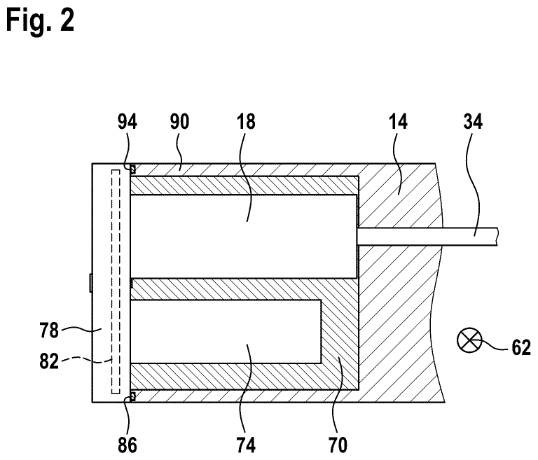

FIG. 2 is a sectional view of the motor housing 14 according to the present invention. The motor housing 14, which is made of a metal material, forms a cup-shaped accommodating space 70 in which the electric motor 18 is accommodated. The motor housing 14 is manufactured by way of a cup extrusion step. By way of such a manufacturing step, the amount of waste material in the form of chips can be significantly reduced compared to forming the motor housing 14 by machining. The motor housing 14 is open at one axial end, allowing the electric motor 18 to be inserted via said open end. In the exemplary embodiment shown, a parking brake device 74 is also arranged in the accommodating space 70 in addition to the electric motor 18. A separate housing for the parking brake device 74 can thus be dispensed with.

At the open axial end of the motor housing 14, said motor housing is closed by a control unit housing 78 in which a control unit 82 that controls the electric motor 18 is arranged. Therefore, no separate cover is needed to close the motor housing 14. In addition, wiring complexity between the electric motor 18 and the control unit 82, as well as between the control unit 82 and the parking brake device 74, can be reduced. A seal 86 is arranged between the control unit housing 78 and the motor housing 14 to prevent the ingress of dirt and moisture into the accommodating space 70. The seal 86 is arranged in a groove 94 formed by an edge 90 of the motor housing 14.

1-10. (canceled)

11. An electromechanical brake for a motor vehicle, the electromechanical brake comprising:
an electric motor which rotationally drives a spindle drive unit arranged in a brake caliper housing, such that a brake actuator for applying a braking force is displaceable in an axial direction of the brake caliper housing;
a motor housing arranged on the brake caliper housing accommodating the electric motor; and
a control unit housing of a control unit that controls the electric motor, the control unit housing being arranged on the motor housing;
wherein the motor housing is made of a metal material and forms a cup-shaped accommodating space in which the electric motor is accommodated, the motor housing being closed by the control unit housing, and the motor housing being formed using a cup extrusion step.

12. The electromechanical brake according to claim 11, wherein the motor housing is formed using a forward cup extrusion step.

13. The electromechanical brake according to claim 11, wherein the motor housing is formed using a backward cup extrusion step.

14. The electromechanical brake according to claim 11, wherein the motor housing is formed using a sideways cup extrusion step.

15. The electromechanical brake according to claim 11, further comprising a seal arranged between an edge of the accommodating space and the control unit housing.

16. The electromechanical brake according to claim 15, wherein the seal is a wet seal.

17. The electromechanical brake according to claim 15, wherein the seal is an elastic solid seal.

18. The electromechanical brake according to claim 15, wherein the edge of the accommodating space is machined.

19. The electromechanical brake according to claim 11, wherein the accommodating space accommodates a parking brake device in addition to the electric motor.

20. A motor vehicle, comprising:
an electromechanical brake, including:
an electric motor which rotationally drives a spindle drive unit arranged in a brake caliper housing, such that a brake actuator for applying a braking force is displaceable in an axial direction of the brake caliper housing,
a motor housing arranged on the brake caliper housing accommodating the electric motor, and
a control unit housing of a control unit that controls the electric motor, the control unit housing being arranged on the motor housing,
wherein the motor housing is made of a metal material and forms a cup-shaped accommodating space in which the electric motor is accommodated, the motor housing being closed by the control unit housing, and the motor housing being formed using a cup extrusion step.
